(19) United States
(12) Patent Application Publication
(10) Pub. No.: US 2020/0323187 A1
(43) Pub. Date: Oct. 15, 2020

(54) CONTAINMENT DEVICE

(71) Applicant: Brett PENROD, Benjamin, UT (US)

(72) Inventor: Brett PENROD, Benjamin, UT (US)

(21) Appl. No.: 16/383,507

(22) Filed: Apr. 12, 2019

(51) Int. Cl. A01K 97/06; A01K 91/03

(52) U.S. Cl. CPC A01K 97/06; A01K 91/03

(57) ABSTRACT

A containment device includes an elongate housing with an opening that allows an anchor hook to be removably inserted. The housing is secured to a fishing pole by at least one locking element.

### BACKGROUND

Hooks and lures and other items are commonly tethered to fishing poles to catch fish. Dangling in the air, they cause damage to the environment and injury to oneself, kids, pets, etc. Therefore, while moving to various fishing locations, hooks and lures are often removed from fishing poles.

### BRIEF DESCRIPTION OF DRAWINGS

The following is a description of the drawings according to principles described herein.

FIG. 1 illustrates a perspective view of a containment device.

FIG. 2 illustrates a perspective view of a containment device.

FIG. 3 illustrates a front view of a containment device.

FIG. 4 illustrates a perspective view of a containment device with a close-up view of a portion of the containment device.

FIG. 5 illustrates a top view of a containment device.

FIG. 6 illustrates a front cutout view of a containment device.

FIG. 7 illustrates a side view of a containment device attached to a fishing pole.

FIG. 8 illustrates a side view of a containment device attached to a fishing pole.

FIG. 9 illustrates a side view of a containment device attached to a fishing pole.

### DETAILED DESCRIPTION

The following describes one or more improvements to protective measures for hooks and lures in the form of a containment device.

Hooks and lures attached to fishing poles are problematic. For example, they may be tethered and left dangling in air while a user moves to various parts of a stream, lake, ocean, or other body of water. They may also be carelessly left on fishing poles when the poles are placed in vehicles. Left exposed, hooks and lures can easily cause damage to surroundings and injury to the users. Care must be taken to remove them from fishing poles. As a result, time and efficiency are lost on a fishing outing.

Also, movement of fishing poles with exposed hooks and lures causes the hooks and lures to hit the poles which potentially damages pole material. For example, common materials used to make poles, such as fiberglass, are worn away or chipped by hooks and lures bouncing around and colliding with the fishing poles.

Hooks and lures can also cause damage to other items besides the poles. For example, hooks and lures can damage the interior of vehicles by making scratches and tearing fabric. Clothing worn by a user can easily become snagged and result in tears. Hooks and lures are sharp which can wound the user's skin beneath clothing or hurt pets. Not only do hooks and lures cause damage to their surroundings, but left exposed on a pole, they pose a damage to themselves. When they contact other things, they may become bent or possibly break. Even when they do not cause damage, they still pose a nuisance for being susceptible to being entangled in the fishing line of the fishing pole.

An exemplary containment device comprises an elongate housing with an opening at a bottom end of the housing and a closed top end of the housing. A slot spans a length of the housing. A first and second anchor hook are located on opposite sides of the housing to be secured by at least one locking mechanism for securing the housing to a fishing pole. The housing further comprises at least one rest member on a side of the housing. The rest member is notched or curved to lay the housing against a cylindrical surface of the fishing pole when the housing is secured by the locking mechanism. The opening of the housing is configured to allow a fishing hook on a line extending from a fishing pole tip to be removably placed within the housing and retained in the slot by the closed bottom when the line is tensioned.

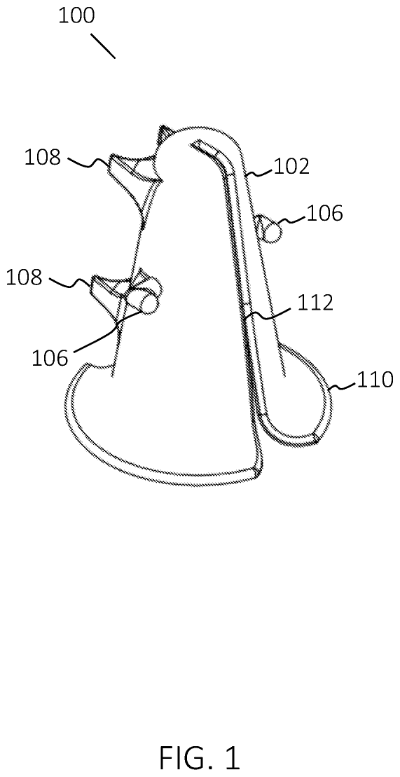

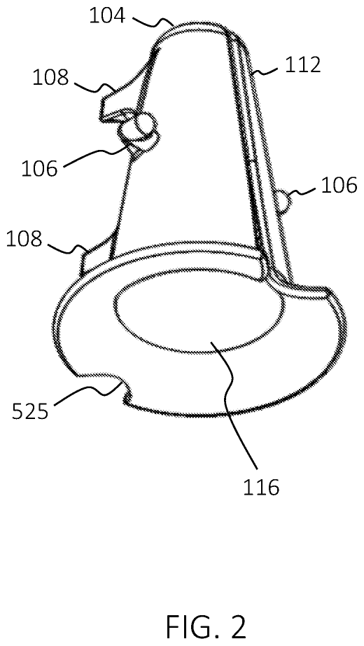

Turning to FIGS. 1-4, a containment device 100 is shown according to principles described herein. The containment device 100 includes a housing 102. The housing 102 includes an elongate cylinder. The housing 102 is tapered as shown so as to form a cone shape. The housing further includes a closed top end and an open bottom end. A hollow within the housing 102 is accessed through the open bottom end.

The cone shape of the housing 102 is advantageous because the relatively larger diameter at the opening allows lures to be easily inserted. The smaller diameter at the closed top end provides a tighter fit to prevent movement of the lure once inside the housing 102. The tighter fit may be a friction fit to keep the lure in place inside the housing 102.

The top end of the housing 102 is the top of the cone shape, which may be pointed, domed, or flat. For example, the top may be generally flat as shown. Alternatively, the top may comprise a circular dome shape with sidewalls transitioning smoothly into annular edges of the dome shape. Alternatively, the edges may turn sharply so as to form sharp or otherwise defined corners around annular edges of the top.

The bottom end of the housing 102 comprises an annular lip 110. The annular lip 110 is formed by a top portion of the housing 102 that extends radially outward from the housing 102. The top portion bends or curves radially outward from a central axis of the housing. The top portion flares outward, forming a bell curve around the end of the housing. The annular lip may curve to extend at a 90 degree angle from the central axis. Alternatively, the annular lip 110 may curve less than 90 degrees. For example, an angle between 45-55, 55-65, 65-75, 75-85, and 85-90 degrees are all anticipated angles that the lip may be extended.

The curve of the annular lip 110 is gradually outward so as to define a smooth contoured interior surface of the hollow. The curve is advantageous because it encourages easy entrance of a hook, lure, or other item to easily slide into and out of the hollow. The curve of the annular lip further protects a fishing line from being cut on a sharp corner.

Variations include that the bend in the annular lip 110 be sharp so as to define a corner edge. Variations further include that the annular lip 110 be a separate flange that is attached to the housing 102.

The annular lip 110 may have a length that is proportional to the length of the cone shape. For example, the ratio of annular lip to housing length may be 1:11, 1:10, 1:9, 1:8, 1:7, 1:6, 1:5, or 1:4. Other ratios are anticipated.

A slot 112 runs along the axial length of the housing 102. The slot 112 is dimensioned for a hook, lure, line, or other fishing component to be removably inserted within the slot 112 and into the hollow of the housing 102. The slot 112 may extend at least partially into the top end of the housing. For example, as shown, the slot 112 extends half way into the top surface, or in other words the radius length, of the top surface of the housing 102.

Other examples include that the slot 112 extend only partially to the center of the top surface. For example, the slot 112 may extend ¼ or ⅓ of the radius of the center of the top surface. Alternatively, the slot 112 may extend the entire length of the center of the top surface, or in other words the diameter length, of the center of the top surface. The slot 112 may instead extend less than the entire length but more than half way. For example, the slot may extend ⅔ or ¾ the length of the top surface.

At the top end of the housing 102, the space defined by the slot 112 starts to become wider with sides of the slot 112 tapering away from each other having sides that are a symmetrical mirror image of each other. The sides may curve away from each other to form two concave edges in a rounded V-shaped opening at the bottom of the slot to smoothly guide a fishing line into and out of the housing. Alternatively, the sides may turn sharply away from each other. For example, the sides may turn sharply so as to define corners at the intersection of the slot 112 and the top edges of the annular lip 110.

The starting point of sides of the slot widening away from each other may be proportional with the length of the housing 102. For example, the starting point ratio to the length of the housing may be 1:11, 1:10, 1:9, 1:8, 1:7, 1:6, 1:5, or 1:4. Other ratios are anticipated.

On a side surface of the housing 102 are located at least two rest members 108. Each rest member 108 is an extension off of a side surface of the housing 102. The rest member 108 is configured to abut or lay the housing against a cylindrical or otherwise rounded surface of a fishing pole. To that end, the rest member 108 may include a notch. The notch may have a shape, such as rounded with curved sides or have a V-shape, the notch to be placed over the rounded surface of the fishing pole, the center of the notch straddling the rounded surface of the fishing pole.

The rest member 108 may rest generally flush against the fishing pole. Alternatively, the fit may include a space between the rest member 108 and the fishing pole 132. The contouring of the rest member 108 may include a rounded surface as shown. Also, the rest member 108 may extend partially into the extension in a manner such that the rest member 108 does not extend into the housing. Alternatively, the rest member 108 may extend into the housing 102. In particular, the rest member 108 may be a cavity within the sidewalls of the housing 102 such that the rest member is defined by sidewalls of the housing 102 and there is no extension at all.

The rest member 108 may include a rounded surface that contacts a corresponding rounded surface of a fishing pole 132, however, other shapes are also anticipated. For example, the rest member may have a V-shape, a shape similar to a V-shape, or a shape that encompasses a portion of a V-shape along with another shape.

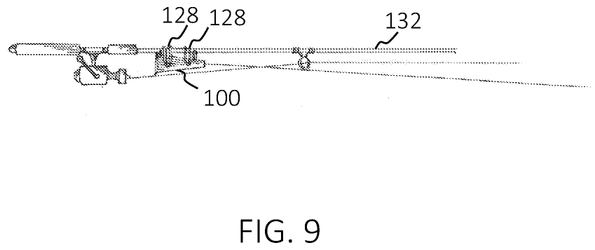

The location of the rest member 108 may be at a point anywhere along a bottom surface of the housing 102. For example, there may be a single rest member 108 located at a midpoint along the bottom surface of the housing 102, as shown in FIG. 8. In another example, there may be two rest members, a first rest member located at approximately ⅓ the length and a second rest member located at approximately ⅔ the length, as shown in FIG. 9.

Other locations are anticipated for the rest member 108. For example, a rest member 108 may be located at ⅛, 1/7, ⅙, ⅕, ¼, ⅓, or ½ the length of the bottom of the rest member 108. If two rest members 108 are used, they may be equidistant relative to respective ends of the housing. Alternatively, the two rest members 108 may be unequal. Additional rest members are anticipated.

At opposite sides of the housing 102 are located at least a first and second locking element. The locking elements are configured to secure the housing to a fishing pole.

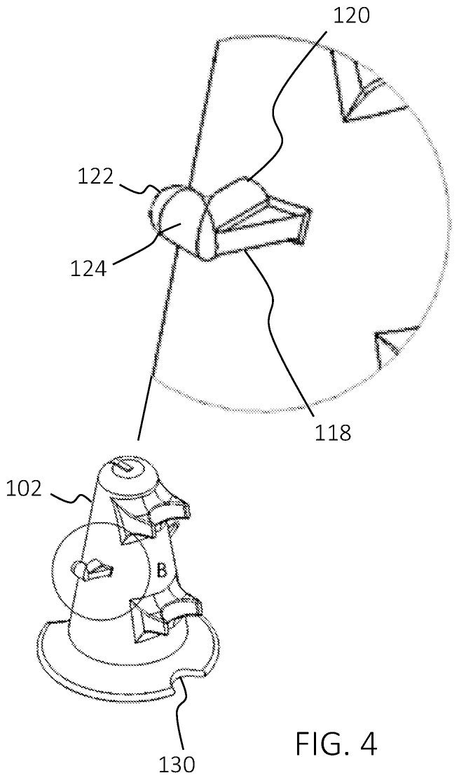

An exemplary locking element may comprise an anchor hook 106 as shown in FIG. 4. The anchor hook 106 comprises a main support or body member that extends radially outward or perpendicularly away from the central axis of the housing 102. The main support 118 as shown includes a rectangular cross-sectional area, however, the cross-sectional area may be other shapes and sizes.

On top of the main support 118 is a hook, or an elongated bended member. The main support includes a rounded top 124. Alternatively, the main support may include a flat top or other type of top surface.

The main support further includes a side support 120 which provides reinforcement for the main support 118 in securing the housing 102 to the fishing pole. The side support 120 is located on the same side in which the hook is facing. The side support 120 may be located on a side of the main support 118 as shown in FIG. 4. Alternatives include that the side support 120 be located on the side of the main support 118 that opposes the side in which the hook is facing.

The side support 118 is a slanted structure added to the main support 120. From the top of the main support 120 to the surface of the housing, the side support 118 extends downward and angles outward away from the main support 120.

The side support 118 may be an independent member that is attached to the main support 120 or alternatively, may be an extension of the main support 118. Variations include that there be a gap between the side support 118 and the main support 120.

Also shown in FIG. 4 is a notch 130 on the annular lip 110. The notch 130 as shown is a round half circle cutout on the annular lip 110. The center of the notch 130 is aligned with the centers of the rest members 108 along the central axis of the housing or along a straight line along the angled side of the housing relative to the central axis. The depth of the notch 130 is configured to allow the angled side of the housing 102 to lay closely to the surface of the fishing pole 132 and be parallel, or closely parallel, to the central axis of the fishing pole 132.

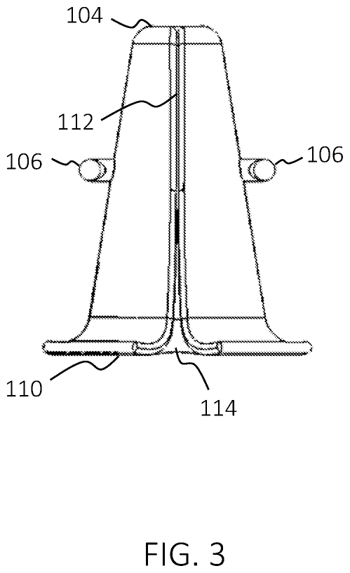

FIG. 3 illustrates that the annular lip 110 extends perpendicular to the central axis of the housing 102 greater than the rest member 108. However, the annular lip 110 extends outward relative to the angled side of the housing 102 less than the rest member 108. The depth of the notch 130 is therefore less than the depth of the rest member 108 to make the housing 102 lay parallel to the fishing pole 132.

Variations include that the depths of the notch 130 and rest members 108 be equal. Rest members 108 and annular lips 110 may have various dimensions and therefore examples include that the notch have a greater depth than the rest member.

The notch 130 described may vary in shape. The notch 130 may conform to the shape of the rest member 108 or it may differ. The notch 130 may be triangular or rounded or have other contouring that allows it to lay against the fishing pole 132.

The anchor hooks 106 are shown in FIG. 3 as being generally located at the midsection of the housing 102. They are diametrically opposed facing away from each other. Alternatives include that they are located at any other location along the side of the housing 102. Also, they may be located closer together and not be at opposing sides.

As shown, the anchor hooks 106 are located at a height that is between the height of the two rest members 108.

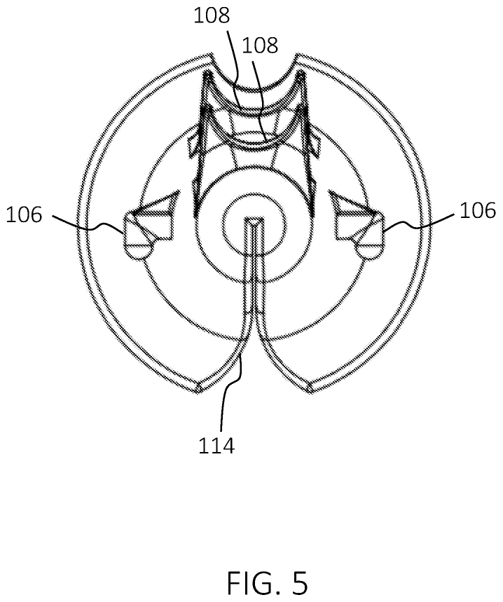

Turning to FIG. 5, a top view of the containment device is shown and provides a symmetrical arrangement. Looking down, one can see that the rest member 108 is diametrically opposed from the curved opening at the top end. Meanwhile, the anchor hooks 106 are arranged at a rotation of 90 degrees from the rest member and the curved opening. The anchor hooks 106 are also diametrically opposed from each other. The top surface is more narrow than the bottom opening and the annular lip 110 has the largest diameter of the housing.

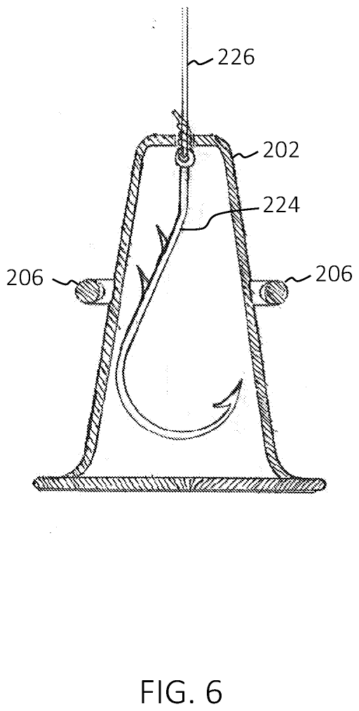

Turning to FIG. 6, a cutout view of the containment device shows the interior surface walls. A hook 224 that has been inserted within the housing may be contained within the housing 202 with the hook having been pulled to be at or near the top end of the housing 202.

The cutout view further illustrates how a fishing line 226 that has been removably inserted within the slot 212 will be positioned after the hook 224 has been placed within the housing 202. As shown, the fishing line 226 extends out of the housing 202 through the slot 212 on the top surface of the housing 202. The fishing line 226 may be tethered so as to extend straight along the axis of the housing 202 or be slightly angled (e.g., less than 30 degrees, less than 20 degrees, less than 10 degrees, less than 5 degrees) and directed along the length of the fishing pole 232. In this manner, the fishing line 226 does not incur additional stresses and strains that could tear the fishing line.

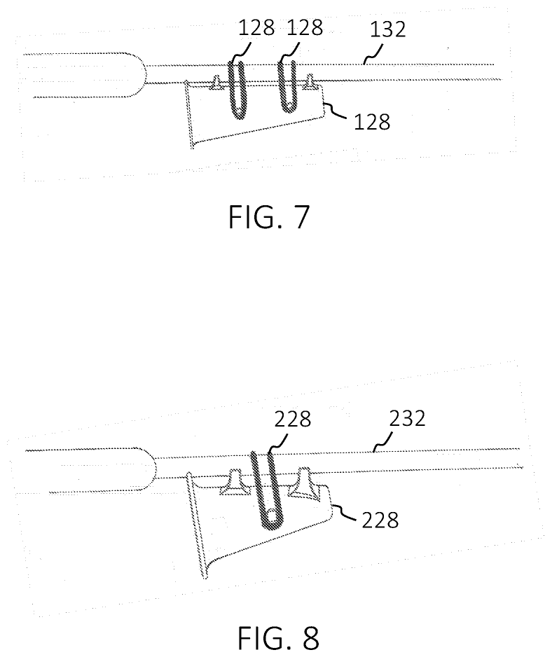

FIG. 7 shows a fully assembled containment device on a fishing pole 132. The housing 102 is shown with two pairs of anchor hooks 128. Each pair of anchor hooks 128 is located on opposite sides of the housing facing away from each other. The housing 102 is attached to a fishing pole by two elastic rings such as the O-rings 128 shown. With the housing placed up against the fishing pole at any desired location along the length of the fishing pole, each O-ring 128 is attached to its respective anchor hook on one side of the housing 102 and then wrapped around the fishing pole to the other side of the housing 102 and attached to the opposing respective anchor hook on the other side of the housing. The assembly is simple and fast and effective in securing the housing to a fishing pole.

The anchor hooks 128 as shown are located on the housing 102 so as to be in parallel alignment with the central axis of a fishing pole 132 when the housing 102 is laying against the fishing pole 132. Alternatively, the anchor hooks 128 may be in parallel alignment with the central axis of the housing 102.

To assemble the device, the housing 102 is placed on the fishing pole 132 at any desired location along the length of the fishing pole. The centers of the rest member 108 and notch 130 are aligned with the axis of the fishing pole 132 so that they rest against the fishing pole. Elastic members, such as the O-rings 128 shown, are attached to the anchor hooks 106 and wrapped around the top of the fishing pole 132. The remaining portion of the O-rings 128 are attached to the opposite facing anchor hooks 106. The O-rings stretch to provide a secure fit.

Once the housing 012 is secured, fishing line 126 with a hook 124 attached is inserted through the bottom opening of the housing 102 and pulled through the slot 112 until the hook cannot move any farther toward the top end. Once stopped, the hook is partially or completely secured within the housing. Note that a lure and other catch related items may also be put in the housing.

Once assembled, inserting a fishing line and lure may be easily accomplished manually with a single hand. This is advantageous because the fishing pole can be maintained for fishing purposes by the other hand while a lure is added to the housing or removed from the housing. It is quick, simple, and function savvy.

To release the hook, the fishing line 126 is pulled through the slot toward the bottom end of the housing 102 and the hook 106 is removed through the bottom opening. The hook 106 is ready to be used to catch a fish. While the hook is being used, the containment device can stay secured to the fishing pole. Whether the containment device is attached on the top, on the side, or underneath the fishing pole, the containment device remains out of the way during fishing. When a user moves to different locations around a lake, river, or other body of water to find a good catch, the fishing hook can be secured in the containment device. When the user is done fishing, the hook can be put back in the containment device and the fishing pole and hook can then be put in a vehicle without concern for the hook and lure and items to tear the upholstered fabric, clothing of the user, skin of the user, kids, and pets, etc. As a result, time and efficiency are used to their advantage on a fishing outing.

An advantage of the containment device is that it is not confined to being attached to an eyelet of the fishing pole. The containment device can be located anywhere along the fishing pole with a surface in which the elastic rings can be attached with the housing. At different stages of fishing, the containment device can be easily moved and relocated to a different position. The user does not have to store the containment device while the fishing pole is not in use because the device can stay on the fishing pole. This is advantageous because the user does not risk losing or misplacing the containment device.

Because the containment device can be attached almost anywhere along the length of the fishing pole, multiple containment devices can be attached to the fishing pole. This allows multiple hooks and other items to be contained.

The anchor hooks 128 may be located along the axial length of the housing between the two heights of the two rest members. As shown, the first pair of anchor hooks 128 is located at approximately ¾ of the height of the housing which is below the height of the top rest member. The second pair of anchor hooks 128 is located approximately ⅖ of the height of the housing which is above the bottom rest member. Alternatively, the spacing may be in thirds, with the first pair at a ⅔ height and the second pair at a ⅓ height of the housing. Also, one or more of the heights of the anchor hooks may be outside the boundary of the heights of the two rest members.

The containment device may come in different sizes. For example, a containment device with only one pair of anchor hooks 128 may be 1″-2″, 2″-3″, 3″-4″, 4″-5″, or 5″-6″ in length. On the other hand, a containment device with two pairs of anchor hooks 128 may be 2″-3″, 3″-4″, 4″-5″, 5″-6″, 6″-7″, 7″-8″, 8″-9″, or 9″-10″ in length. Diameters of the containment device may also change according to the length.

FIG. 8 illustrates a containment device having a single pair of anchor hooks 228 in which to secure the housing to the fishing pole 232. As shown, the anchor hooks 106 are located at a height that is at a midpoint between the height of the two rest members 108.

The advantage to having only one pair of anchor hooks is only having to use one elastic member, such as the O-ring 228 shown. One side of the O-ring is attached to one anchor hook 228 and then wrapped around the fishing pole to secure the opposite side of the O-ring to the opposing anchor hook 228.

FIG. 6 also shows a single pair of anchor hooks 228. The anchor hooks 228 are located at or near the midsection of the housing 202 along the central axis of the housing. Other locations are anticipated along the length of the housing 102. Also, the anchor hooks 228 are on opposite sides of the housing to evenly distribute force around the midsection of the housing 202.

FIG. 9 illustrates a fishing pole 132 with the housing secured near a bottom end of the fishing pole 132. The housing 102 may be secured anywhere along the length of the fishing pole 132 however. It is not restrained to being secured to an eyelet. After use, there is an option of leaving the housing 102 attached to the fishing pole or removing the housing for storing it separately. Because of the mounting which keeps the device attached securely to the fishing pole in a relatively stable manner that is not prone to movement, the device is not subject to damage from movement. Devices that dangle from a fishing pole could easily bend or cause damage to the fishing pole or eyelet. Also, device that dangle could lead to the device being detached from the pole during transport of the fishing pole. The housing as described securely attached to a fishing pole and does not fall off during transport.

Materials for the containment device include a hard rigid plastic, pliable plastic, silicon, metal, and a combination thereof. One or more of the outer surface and the interior surface of the containment device may have a smooth surface that allows the fishing line and the hook and lure to glide over the surface smoothly. Alternatively, one or more of the outer surface and the interior surface of the containment device may have a rough surface. For example, a surface may have bumps or sand paper like qualities that make it more difficult for the hook and lure to move and more easy for hands to grip.

Also, one or more surfaces of the containment device may comprise a properties that provide friction. For example, the outer facing surface area of the rest member may include properties that prevent the containment device from slipping on the fishing pole. The material may comprise rubber, plastic, or other material with properties that provide a friction fit.

The elastic ring is of material with elastic properties, such as plastic, silicon, and other materials with stretch. Instead of an elastic ring, other locking members are anticipated. For example, an elongate member such as strip of cloth or plastic may be used. Holes at free ends of the elongate member may be used to attach to anchor hooks. The member may have elastic properties or be rigid.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A containment device comprising;
an elongate housing;
an opening at a bottom end of the housing and closed top end of the housing;
a slot that spans a length of the housing:
a first and second anchor hook on opposite sides of the housing to be secured by at least one elastic ring for securing the housing to a fishing pole;
at least one rest member on the a side of the housing, the rest member having a notch that lays against a cylindrical surface of the fishing pole when the housing is secured by the elastic ring,
the opening of the housing configured to allow a fishing hook on a line extending from a fishing pole tip to be removably placed within the housing and retained in the slot by the closed top end when the line is tensioned.

2. The containment device of claim 1, wherein the housing includes a cone shape.

3. The containment device of claim 2, wherein the cone shape narrows from the bottom end to the top end.

4. The containment device of claim 1, wherein the opening at the bottom end of the housing is funnel shaped with outer edges curving away from a central axis of the housing.

5. The containment device of claim 4, wherein the outer edges extend radially outward from and perpendicular to a central axis of the housing.

6. The containment device of claim 1, wherein the opening at the bottom end includes edges that curve into the slotted opening.

7. The containment device of claim 1, wherein the first and second anchors are diametrically opposed on the housing.

8. The containment device of claim 7, wherein the first and second anchors include hook-like members.

9. The containment device of claim 1, wherein the at least one rest member is curved to conform to an outer surface of a fishing pole.

10. A containment device comprising;
an elongate housing;
a closed top at a top end of the housing and an opening at a bottom end;
a slot that spans a length of the housing:
a first and second anchor hook on opposite sides of the housing to be secured by at least one locking element for securing the housing to a fishing pole;
at least one rest member on the a side of the housing, the rest member being notched to lay the housing against a cylindrical surface of the fishing pole when the housing is secured by the locking element,
the opening of the housing configured to allow a fishing hook on a line extending from a fishing pole tip to be removably placed within the housing and retained in the slot by the closed top when the line is tensioned.

11. The hook cover of claim 10, wherein the locking mechanism includes an elastic component.

12. The hook cover of claim 10, wherein the housing includes a cone shape.

13. The hook cover of claim 12, wherein the cone shape narrows from the bottom end to the top end.

14. The hook cover of claim 9, wherein the opening at the bottom end of the housing is funnel shaped with outer edges curving away from a central axis of the housing.

15. The hook cover of claim 14, wherein the outer edges extend radially outward from and perpendicular to a central axis of the housing.

16. The hook cover of claim 10, wherein the opening at the bottom end includes edges that curve into the slotted opening.

17. The hook cover of claim 10, wherein the first and second anchor are diametrically opposed on the housing.

18. The hook cover of claim 10, wherein the first and second anchors include hook-like members.

19. The hook cover of claim 10, wherein the at least one rest member is curved to conform to an outer surface of a fishing pole.
